(19) United States
(12) Patent Application Publication
(10) Pub. No.: US 2008/0164645 A1
(43) Pub. Date: Jul. 10, 2008

(54) Increased axial rate and improved durability of an elastomeric bushing

(75) Inventors: Robert J. Bost, Medina, OH (US); Ronald J. McLaughlin, Maumee, OH (US)

Correspondence Address: HARNESS, DICKEY & PIERCE, P.L.C., P.O. BOX 828, BLOOMFIELD HILLS, MI, 48303, US

(73) Assignee: The Pullman Company, Milan, OH (US)

(21) Appl. No.: 11/651,952

(22) Filed: Jan. 10, 2007

(51) Int. Cl. F16F 15/00; B29D 31/00

(52) U.S. Cl. 267/140.12; 29/896.93

(57) ABSTRACT

An elastomer bushing having an increased axial rate, improved durability, and high fatigue life due to the compression and confinement of the rubber element is provided. The manufacture of the elastomer journal is conventional for commercial vehicle applications. In a primary embodiment, the rubber is bonded to a bar pin by an adhesive, wherein the rubber journal is then subsequently assembled into an outer tube. After assembly, the outer tube is curled to retain the rubber journal, and the center of the outer tube diameter is swaged or compressed so as to deform the outer tube into the rubber. The compressed groove in the outer tube comprises the unique feature of this bushing design. This groove provides a mechanical “footing” that resists movement when an axial load is applied.

### FIELD OF THE INVENTION

The present invention relates to articulating bushings. More specifically, this invention relates to the manufacturing of bushings having an increased axial rate and durability for use in torque rods, leaf springs, independent control arms, and the like.

### BACKGROUND OF THE INVENTION

Applications for a cartridge-style bushing include, but are not limited to, torque rods, leaf springs, independent suspension control arms, and other suspension control rods. These and other applications are used on a wide variety of vehicles such as trucks, buses, off-highway vehicles, rail cars, and other automotive applications.

Current bushing designs utilize either a curled outer tube or washers (bonded or non-bonded) to add confinement to the rubber, which improves durability as well as increases the axial rate of the bushing. One such example is shown in U.S. Pat. No. 6,845,995 issued to Cai et al. This prior art design teaches of a suspension-bar assembly for an automotive vehicle including a suspension bar having a bushing; a bushing retainer that exerts radially and axially compressive forces onto the bushing such that the bushing is in frictional engagement with the suspension bar, thereby preventing relative movement of the bushing and the suspension bar; and a mounting bracket that is adapted to connect the suspension bar to the automotive vehicle.

As known in the art, rubber works best in compression; therefore, by adding features such as washers, curling the outer tube, or ball shaping the profile of the inner meal, higher load capacities can be achieved as well as improved life expectancy of the bushing.

An alternative method is to swage or to compress the diameter of the bushing along the entire length of the outer tube, which improves durability and increases radial load-carrying capacity, but does not give high axial rates which are often desired in such applications. One such example is shown in U.S. Pat. No. 5,290,018 issued to Wantanabe et al. This patent teaches of a cylindrical damping bushing for securing a rod-shaped vibrating body to a base. The bushing includes a cylindrical vibration-damping rubber body having an inner bore through which the vibrating body is inserted. An upper side surface thereof comes into contact with the base while the remaining outer side surface thereof is retained by a bracket which is secured to the base.

These and other existing bushings often use expensive washers that are bonded to the elastomer, ball-shaped inner metals, and retaining rings to achieve high axial rates. The addition of washers or ball-shaped inner metals increases the cost of the bushing as well as makes the assembly more complex to manufacture. Swaging along the entire length does not give the additional axial rate desired. Furthermore, the curling feature alone does not provide high enough axial rates or axial load-carrying capacity for certain applications, such as an independent suspension.

### SUMMARY OF THE INVENTION

The disadvantages in the prior art are overcome by the present invention providing for the increased axial rate of the bushing by approximately 130% over the same bushing without the swaged feature.

It is proposed herein that an object of the present invention is to provide a bushing having a high axial rate from 8,100 lbs./in. up to 18,600 lbs./in. and having increased durability for use in a wide variety of applications.

A further object of the present invention is to provide an elastomer bushing which is economical to manufacture and less complex to assemble than the prior art.

These and other advantages will become apparent in the present invention describing an elastomer bushing having a high fatigue life due to the compression and confinement of the rubber. The manufacture of the elastomer journal is conventional for commercial vehicle applications. In a primary embodiment, the rubber is bonded to a bar pin by an adhesive, wherein the rubber journal is then subsequently assembled into an outer tube. After assembly, the outer tube is curled to retain the rubber journal, and the center of the outer tube diameter is swaged or compressed so as to deform the outer tube into the rubber. The compressed groove in the outer tube comprises the unique feature of this bushing design. This groove provides a mechanical “footing” that resists movement when an axial load is applied.

### BRIEF DESCRIPTION OF THE DRAWINGS

The present invention will become more fully understood from the detailed description and the accompanying drawings, wherein:

FIG. 1 is a cross-sectional and respective end view of the preferred embodiment of the present bushing assembly;

FIG. 2 is a cross-sectional and respective end view of the preferred embodiment of the present bushing assembly prior to insertion into outer tube;

FIG. 3 is a cross-sectional and respective end view of the preferred embodiment of the present bushing assembly with outer tube installed, prior to curling and swaging;

FIG. 4 is a cross-sectional and respective end view of the preferred embodiment of the present bushing assembly with outer tube installed after curling;

FIG. 5 is a cross-sectional and respective end view of an alternative embodiment of the present invention embodying a ball-shaped profile on the inner metal, with the outer tube installed and curled;

FIG. 6 is a cross-sectional view of an alternative embodiment prior to insertion in the outer tube;

FIG. 6A is a cross-sectional and end view of the embodiment of FIG. 6 after outer tube is installed, curled, and swaged; and

FIG. 7 is a cross-sectional top-side view of the embodiment shown in FIG. 6A.

### DETAILED DESCRIPTION OF THE PREFERRED EMBODIMENTS

The following description of the preferred embodiments is merely exemplary in nature and is in no way intended to limit the invention, its application, or uses.

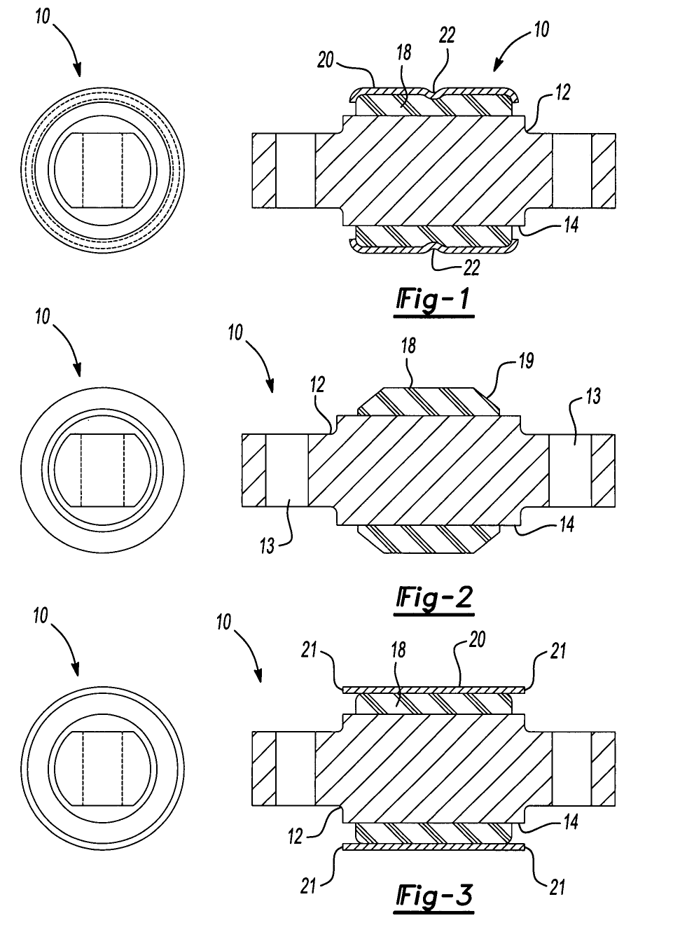

Referring initially to FIG. 1, the preferred embodiment of the present bushing assembly 10 is shown. Comprising an inner metal element 12 which attaches to the desired application such as a leaf spring, torque rod, or control arm by means of attachment throughbores 13, the inner metal element 12 features a central bushing attachment diameter 14 positioned between the attachment ends. A rubber/elastomer element 18 is positioned around the central bushing attachment diameter 14, which may be optionally affixed to the inner metal element by an adhesive means.

An outer tube 20 is subsequently placed over the rubber/elastomer element 18 which may also optionally be affixed to the rubber/elastomer element 18 by means of adhesive. The outer tube 20 is then subsequently curled inward around the rubber/elastomer element 18 at the distal ends of the tube to improve the durability of the bushing as well as maintain the position of the rubber/elastomer element 18.

The center of the outer tube 20 is then swaged 22 around the outer diameter so as to indent into the rubber/elastomer element 18.

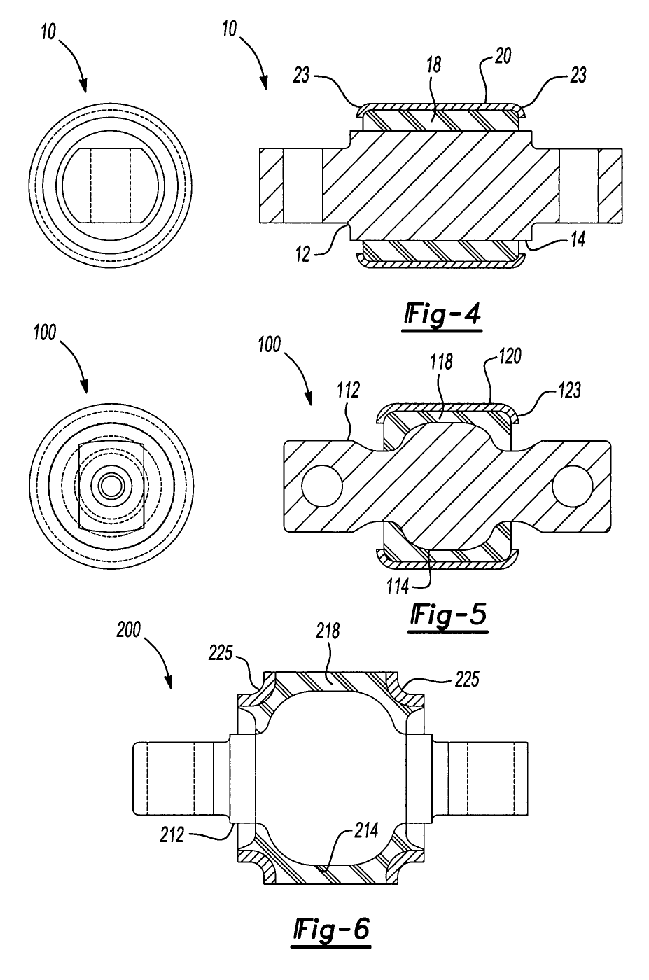

Referring now to FIG. 2, the bushing assembly 10 is shown prior to insertion within the outer metal tube. As shown in this figure, the elastomer element may optionally be tapered on the distal ends 19 to provide ease of insertion of the bushing assembly 10 within the outer tube. FIG. 3 shows a detailed view of the bushing assembly 10 inserted within the outer metal tube 20, prior to the distal ends 21 being curled inward around the rubber/elastomer element 19, retaining and compressing it against the inner metal element 12. FIG. 4 shows the next step in the assembly process wherein the distal ends of the outer metal tube 20 are curled inward radially in flanges 23, retaining the rubber/elastomer element 18 against inner metal element 12.

FIG. 5 illustrates an alternative embodiment of a bushing assembly 100 wherein the inner metal element 112 comprises a ball-shaped inner profile 14 proximate the location of the rubber/elastomer element 118 mounting location. This embodiment provides for improved durability and increased radial load-carrying capacity.

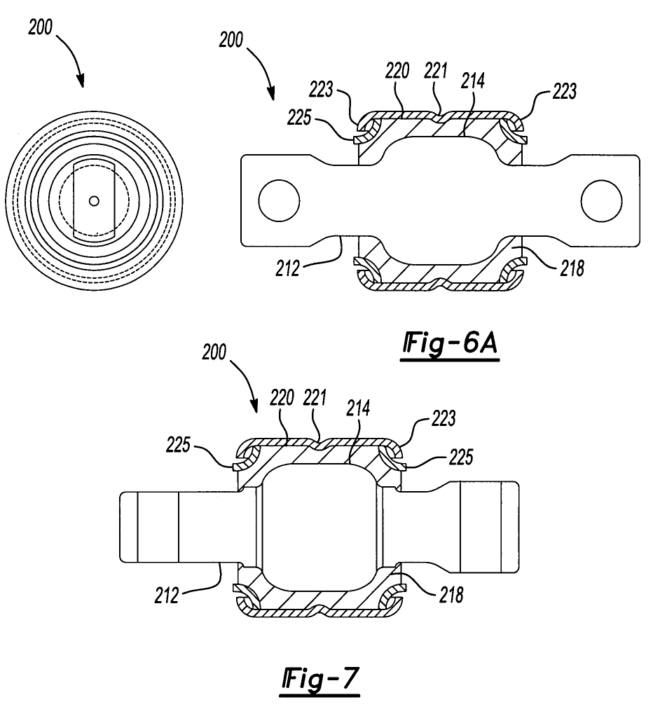

Referring now to FIGS. 6, 6A, and 7, collectively, these figures illustrate a similar embodiment to FIG. 5 utilizing a ball-shaped inner profile 214 of inner metal element 212. In this embodiment, the distal edges of the rubber/elastomer element 218 are crimped with retaining rings 225 to prevent outward push out of the rubber/elastomer element 118 once the outer metal tube 220 is positioned over the assembly and curled inward on distal ends 223 and swaged around the center position 221.

As disclosed, the component can be manufactured with relative ease. After curling the ends of the outer metal tube of the bushing assembly, the center of the bushing can be swaged at the same manufacturing station. There are no additional components needed, and axial rate is increased as well as durability over bushings lacking these features.

In further alternative embodiments intended to be within the scope of the present invention, in place of swaging the outer diameter of the outer tube, the inner diameter could be machined to have a central rib, giving the same effect as the deformation of the outer tube. In some cases where a very high axial rate is needed and cost is not as significant as performance, the swage feature could be incorporated into a bushing that utilizes washers and a ball-style inner metal wall, as well. This invention could optionally further incorporate alternative rubber journal shapes with a groove in the center of the elastomer surface, which would further enhance the axial rate.

It is of further importance that the description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cartridge elastomer bushing assembly having high axial rate and improved durability comprising:
an inner metal element, said inner metal element having a generally round diameter proximal a center line of said inner metal element and having attachment means proximal the distal ends of said inner metal element;
a complementary elastomeric element having a throughbore, said elastomeric element surrounding said inner metal element proximal the center line of said inner metal element; and
an outer metal tube element, said outer metal tube element having an inside diameter generally complementary to the outside diameter of said elastomeric element, said outer metal tube element being positioned over said elastomeric element;
wherein said elastomeric element is positioned over said inner metal element; said outer metal tube element is positioned over said elastomeric element; and said outer metal tube is swaged inward around its diameter proximal the center line so as to deform inward, creating axial force upon said elastomeric element and said inner metal element.

2. The cartridge elastomer bushing assembly of claim 1, wherein said elastomeric element is adhesively attached to said inner metal element.

3. The cartridge elastomer bushing assembly of claim 1, wherein said outer metal tube is adhesively attached to said elastomeric element.

4. The cartridge elastomer bushing assembly of claim 1, wherein said outer metal tube is partially curled radially inward at the distal ends around said elastomeric element.

5. The cartridge elastomer bushing assembly of claim 2, wherein said outer metal tube is partially curled radially inward at the distal ends around said elastomeric element.

6. The cartridge elastomer bushing assembly of claim 3, wherein said outer metal tube is partially curled radially inward at the distal ends around said elastomeric element.

7. The cartridge elastomer bushing assembly of claim 6, wherein said inner metal element comprises an increased diameter proximal its center line.

8. The cartridge elastomer bushing assembly of claim 7, wherein the distal ends of said elastomeric element are retained by a pair of retainer rings retained within said curled ends of said outer metal tube.

9. A method of manufacturing a cartridge elastomer bushing having high axial load rate comprising the steps of torque rod with elastomer retainer comprising the steps of:
(a) forming an inner metal element having a radial external diameter and mounting means proximal the distal ends of said inner metal element;
(b) inserting said inner metal element within a generally complementary inner bore of a cylindrical elastomeric element so as said elastomeric element surrounds said external diameter of said inner metal element;
(c) inserting said inner metal element and said elastomeric element assembly into an outer metal tube, so as said outer metal tube surrounds said elastomeric element;
(d) partially curling the distal ends of said outer metal tube inward around the distal ends of said elastomeric element; and
(e) swaging said outer metal tube, proximal the center line inward, so as to deform the elastomeric element radially inward.
